(19) United States
(12) Patent Application Publication
(10) Pub. No.: US 2011/0106853 A1
(43) Pub. Date: May 5, 2011

(54) DECLARATIVE MODEL SECURITY PATTERN

(75) Inventors: James Patrick Seymour Baker, Kirkland, WA (US); Anthony C. Bloesch, Vashon, WA (US); Igor Sakhnov, Kirkland, WA (US); Keith W. Short, Redmond, WA (US)

(73) Assignee: Microsoft Corporation, Redmond, WA (US)

(21) Appl. No.: 12/609,618

(22) Filed: Oct. 30, 2009

(51) Int. Cl. G06F 17/30

(52) U.S. Cl. 707/781; 707/E17.005

(57) ABSTRACT

The present invention extends to methods, systems, and computer program products for a declarative model security pattern for use in a database. Declarative language code can include a declared access control predicate and a separately declared data structure definition bound to the access control predicate. A portion of the database is instantiated from the declarative language code. The instantiated portion of the database includes one or more tables and a view of the one or more tables. A database management system enforces the access control predicate by dynamically calculating a value for the access control predicate and using the dynamically calculated value to define what operations may be performed on data in the one or more tables via the view.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

Some computer systems may include database management systems. Unfortunately, database management systems typically provide relatively few access rights features. Accordingly, access rights are often implemented using middle-tier software programs through which client programs can communicate with the database management systems. These middle-tier-implemented access-rights programs, however, can be error prone, slow and inflexible.

### BRIEF SUMMARY

The present invention extends to methods, systems, and computer program products for a declarative model security pattern for use in a database. In some embodiments, declarative language code is translated into one or more statements. The declarative language code includes a declared access control predicate and a separately declared data structure definition. The declared data structure definition is bound to the access control predicate.

The one or more statements are executed to instantiate at least a portion of the database. The database is hosted by a database management system. The instantiated portion of the database includes one or more tables and a view of the one or more tables. The database management system dynamically calculates a value for the access control predicate. The database management system uses the dynamically calculated value to define what operations may be performed on data from the one or more tables via the view.

The present invention also extends to methods, systems, and computer program products for dynamically calculating a value for an access control predicate and using the dynamically calculated value to define what operations may be performed on data from one or more tables of a database via the view. The view and the tables of the database were instantiated by executing one or more statements translated from declarative language code. The declarative language code includes a declared access control predicate and a declared data structure definition bound to the access control predicate. The access control predicate is declared separately from the data structure definition.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates providing security for databases;

FIG. 2 illustrates a flow chart of an example method that facilitates providing security for databases;

FIG. 3 illustrates a flow chart of an example method that facilitates providing security for databases; and

FIG. 4 illustrates a flow chart of an example method that facilitates defining what data a view may access.

### DETAILED DESCRIPTION

The present invention extends to methods, systems, and computer program products for a declarative model security pattern for use in a database. In some embodiments, declarative language code is translated into one or more statements. The declarative language code includes a declared access control predicate and a separately declared data structure definition. The declared data structure definition is bound to the access control predicate.

The one or more statements are executed to instantiate at least a portion of the database. The database is hosted by a database management system. The instantiated portion of the database includes one or more tables and a view of the one or more tables. The database management system dynamically calculates a value for the access control predicate. The database management system uses the dynamically calculated value to define what operations may be performed on data from the one or more tables via the view.

The present invention also extends to methods, systems, and computer program products for dynamically calculating a value for an access control predicate and using the dynamically calculated value to define what operations may be performed on data from one or more tables of a database via the view. The view and the tables of the database were instantiated by executing one or more statements translated from declarative language code. The declarative language code includes a declared access control predicate and a declared data structure definition bound to the access control predicate. The access control predicate is declared separately from the data structure definition.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

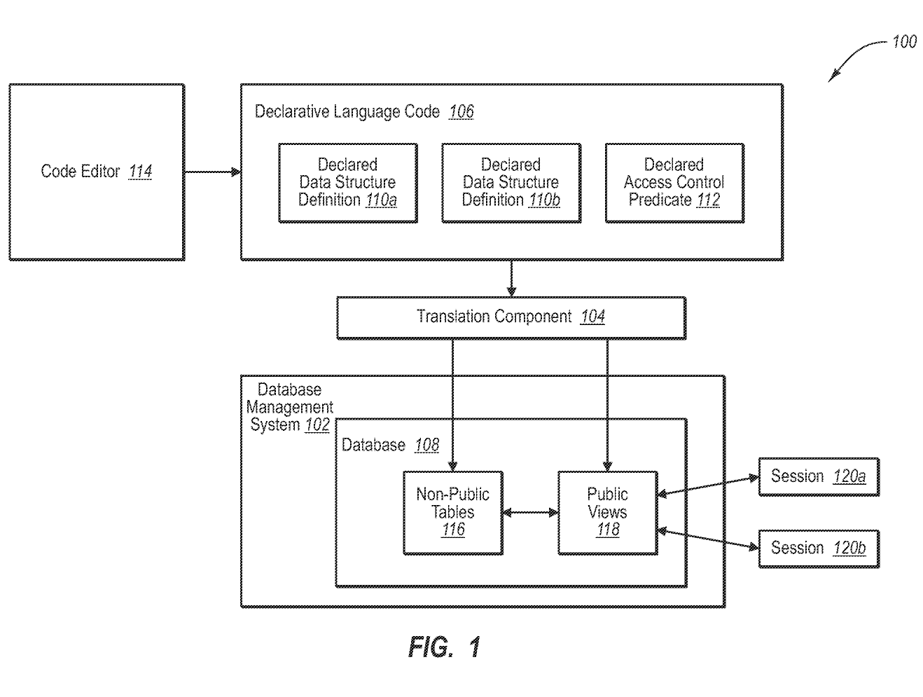

FIG. 1 illustrates an example computer architecture 100 that facilitates providing security for databases. Referring to FIG. 1, computer architecture 100 may include database management system 102 and translation component 104. Each of the depicted components may be connected to one another over (or is part of) a network, such as, for example, a Local Area Network (“LAN”), a Wide Area Network (“WAN”), and even the Internet. Accordingly, each of the depicted components as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Translation component 104 may be configured to translate declarative language code 106 into SQL statements that, when executed, instantiate at least a portion of database 108. In further detail, declarative language code 106 can include one or more declared data structure definitions 110 (110a, 110b, etc.) and one or more separately declared access control predicates 112. Data structure definitions 100 can be bound to declared access control predicates 112, thereby supporting increased reuse of access control predicates within declared access control predicates 112.

Declarative language code 106 may be written in a declarative language, such as the M language or other suitable declarative language. For example as depicted, computer architecture 100 includes code editor 114. Code editor 114 can used to create and/or edit declarative language code 106. It will be appreciated, however, that translation component 104 need not be configured to translate declarative language code 106 into SQL statements and may, for example, translate declarative language code 106 into other types of statements, instructions or the like that, when executed, instantiate at least a portion of a database 108.

Access control predicates 112 can be declared separately from the data structure definitions 110. Advantageously, separately declaring access control predicates 112 assists in distinguishing what portions of the code relate to data and what portions of the code relates to controlling access to the data. In addition, when access control predicate 112 is declared separately, multiple data structure definitions 110 can be bound to access control predicate 112. That is, the access control predicate 112 is easily reused. Reuse of access control predicates facilitates consistent access to database 108 based on declarative language code 106.

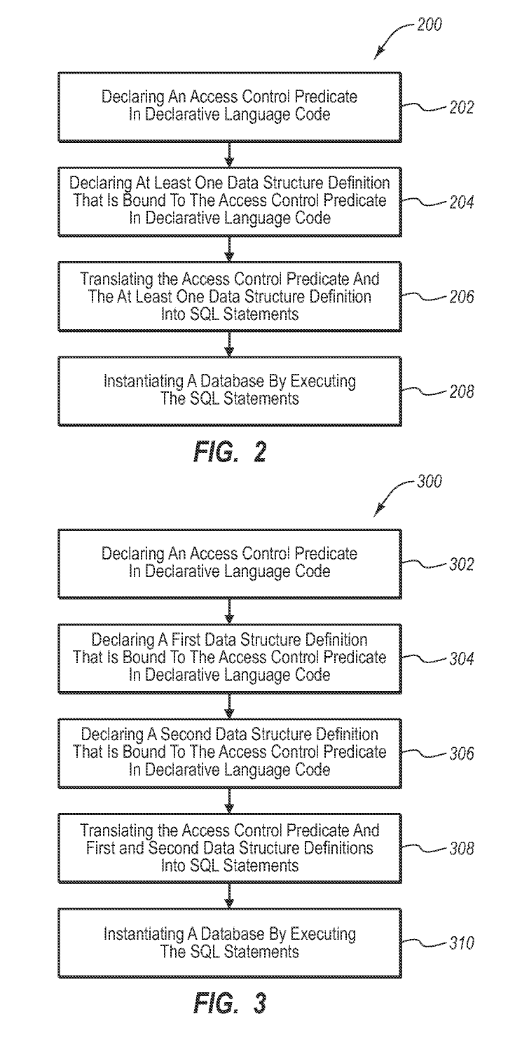

FIG. 2 illustrates a flow chart of an example method 200 that facilitates providing security for databases. Method 200 will be described with respect to the components and data of computer architecture 100.

Method 200 includes of declaring an access control predicate in declarative language code (act 202). For example, code editor 114 can be used to declare access control predicate 112 in declarative language code 106.

Method 200 includes an act of declaring at least one data structure definition that is bound to the access control predicate in declarative language code (act 204). For example, code editor 114 can be used to declare one or more data structure definitions 110 and bind the one or more data structure definitions 110 to access control predicate 112.

Method 200 includes an act of translating the access control predicate and the at least one data structure definition into Structured Query Language (SQL) statements (act 206). For example, translation component 104 can translate access control predicate 112 and one or more data structure definitions 110 into one or more SQL statements. The SQL statements can written in T-SQL or in other dialects of SQL. Method 200 includes an act of instantiating a database by executing the SQL statements (act 208). For example, database management system 102 may instantiate at least a portion of database 108 by executing the SQL statements (translated from declarative language code 106). The instantiated portion of database 108 can include one or more tables, such as, for example, non-public tables 116. The instantiated portion of database 108 can also one or more views, such as, for example, public views 118. Public views 188 can be views of non-public tables 116.

In some embodiments, translation component 104 translates access control predicate 112 and one or more data structure definitions 110 into other types of statements, instructions or the like that may be executed to instantiate at least a portion of a database 108.

FIG. 3 illustrates a flow chart of an example method 300 that facilitates providing security for databases. Method 300 will be described with respect to the components and data of computer architecture 100.

Method 300 includes an act of declaring an access control predicate in declarative language code (act 302). For example, code editor 114 can be used to declare access control predicate 112 in declarative language code 106.

Method 300 includes an act of declaring a first data structure definition that is bound to the access control predicate in declarative language code (act 304). For example, code editor 114 can be used to declare data structure definition 110a and bind data structure definition 110a to the access control predicate 112.

Method 300 includes an act of declaring a second data structure definition that is bound to the access control predicate in declarative language code (act 306). For example, code editor 114 can be used to declare data structure definition 110b and bind data structure definition 110b to access control predicate 112 (thereby reusing access control predicate 112).

Method 300 includes an act of translating the access control predicate and the first and second data structure definitions into SQL statements (act 308). For example, translation component 104 may translate access control predicate 112 and data structure definitions 110a, 110b into one or more SQL statements. Method 300 includes an act of instantiating a database by executing the SQL statements (act 310). For example, database management system 102 can instantiate at least a portion of the database 108 by executing the SQL statements (translated from access control predicted 112 and data structure definitions 110a, 110b). The instantiated portion database 108 includes one or more non-public tables 116 and one or more views 118 of the one or more tables.

In some embodiments, translation component 104 translates access control predicate 112 and data structure definitions 110a, 110b into other types of statements, instructions or the like that may be executed to instantiate at least a portion of a database 108.

Accordingly, database management system 102 can enforce an access control predicate, such as the access control predicate that was declared as part of act 202 (FIG. 2) or act 302 (FIG. 3). More particularly, database management system 102 can be configured to dynamically calculate a value for access control predicate 112 and then use the dynamically calculated value to define what operations may be performed on data from non-public tables 116 via public views 118. For example, the dynamically calculated value may define, at a row level, what operations may be performed on data in non-public tables 116 via the public views 118. The dynamically calculated value can define, with varied granularity (e.g., element level, row level, table level, etc.), what operations may be performed on data in non-public tables 116 via public views 118. Thus, in some embodiments, security can be expressed as the intersection between rows that satisfy a security predicate and a user's granted operations for those rows.

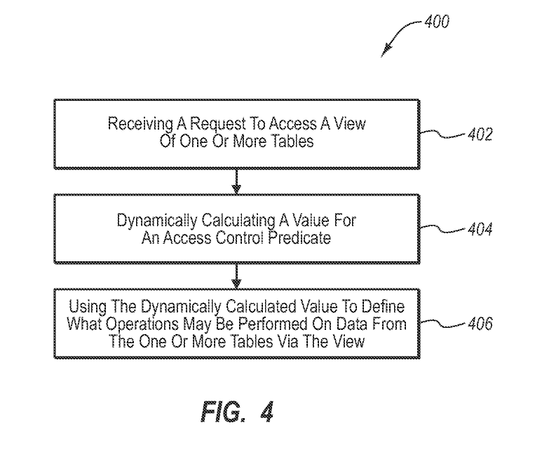

FIG. 4 illustrates a flow chart of an example method 400 that facilitates defining what data one or more views 118 can access. Method 400 will be described with respect to the components and data of computer architecture 100.

Method 400 includes an act of receiving a request to access a view of one or more tables (act 402). For example, session 120a can be created within database management system 102 Subsequent to session creation, database management system 102 can receive a request from session 120a to access a public view 118 of one or more non-public tables 116.

Method 400 includes an act of dynamically calculating a value for an access control predicate (act 404). For example, database management system 102 in response to the session 120 requesting access to the view 118, can dynamically calculate a value for the access control predicate 112. Method 400 includes an act of using the dynamically calculated value to define what operations may be performed on data from the one or more tables via the view 118 (act 406). For example, database management system 102 can use the dynamically calculated value to define what operations session 120a can perform on data from one or more non-public tables 116 via view 118. When appropriate, the dynamically calculated value for access control predicate 112 can be based on one or more claims associated with the session 120a that are used for claims-based accessed control.

Accordingly, embodiments of the invention facilitate row level (or other granularity) access control in an SQL server database or other types of databases using declarative access control predicates. The access control predicates can be expressed in a declarative manner separately from the data structure definitions (tables) that they restrict access to. Thus, predicates can be reused across multiple data structure definitions. Predicates can also be based on results of database queries, making access membership dynamic.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a method comprising:
translating declarative language code into one or more statements, the declarative language code including:
a declared access control predicate; and
a declared data structure definition bound to the access control predicate, the access control predicate declared separately from the data structure definition; and
instantiating at least a portion of a database by executing the one or more statements, the database being hosted by a database management system, the at least a portion of a database including:
one or more tables; and
a view of the one or more tables, the database management system configured to enforce the access control predicate by dynamically calculating a value for the access control predicate and using the dynamically calculated value to define what operations may be performed on data from the one or more tables via the view.

2. The method as in claim 1, wherein the dynamically calculated value defines, at a row level, what operations may be performed on data from the one or more tables via the view.

3. The method as in claim 1, wherein the dynamically calculated value is based on one or more claims associated with a session with the database management system.

4. The method as in claim 3, wherein the database management system is configured to, in response to the session requesting access to the view, dynamically calculate the value for the access control predicate.

5. The method as in claim 1, wherein the dynamically calculated value defines, at a row level, what operations may be performed on data from the one or more tables via the view; and
wherein the dynamically calculated value is based on one or more claims associated with a session with the database management system.

6. The method as in claim 5, wherein the database management system is configured to, in response to the session requesting access to the view, dynamically calculate the value for the access control predicate.

7. The method as in claim 1, wherein the declarative language code is written in the M language.

8. A computing system comprising:
one or more processors;
system memory; and
one or more computer storage media having stored thereon computer-executable instructions for performing a method, the method including:
dynamically calculating a value for an access control predicate; and
using the dynamically calculated value to define what operations may be performed on data from one or more tables of a database via a view, the view and the one or more tables of the database having been instantiated by an execution of one or more statements translated from declarative language code, the declarative language code including:
a declared access control predicate; and
a declared data structure definition bound to the access control predicate, the access control predicate declared separately from the data structure definition.

9. The system as in claim 8, wherein the dynamically calculated value defines, at a row level, what operations may be performed on data from the one or more tables via the view.

10. The system as in claim 8, wherein the dynamically calculated value is based on one or more claims associated with a session with a database management system that hosts the database.

11. The system as in claim 10, wherein the database management system is configured to, in response to the session requesting access to the view, dynamically calculate the value for the access control predicate.

12. The system as in claim 8, wherein the dynamically calculated value defines, at a row level, what operations may be performed on data from the one or more tables via the view; and
wherein the dynamically calculated value is based on one or more claims associated with a session with a database management system that hosts the database.

13. The system as in claim 12, wherein the database management system is configured to, in response to the session requesting access to the view, dynamically calculate the value for the access control predicate.

14. At a computer system including one or more processors and system memory, a method comprising:
translating declarative language code into one or more SQL statements, the declarative language code including:
a declared access control predicate;
a first declared data structure definition bound to the access control predicate, the access control predicate declared separately from the first data structure definition; and
a second declared data structure definition bound to the access control predicate, the access control predicate declared separately from the second data structure definition; and
instantiating at least a portion of a database by executing the one or more SQL statements, the database being hosted by a database management system, the at least a portion of a database including:
a plurality of tables;
a first view of at least one of the tables; and
a second view of at least one of the tables, the database management system configured to enforce the access control predicate by dynamically calculating a value for the access control predicate and using the dynamically calculated value to define what operations may be performed on data from at least one of the tables via the first view and to define what operations may be performed on data from at least one of the tables via the second view.

15. The method as in claim 14, wherein the dynamically calculated value defines, at a row level, operations may be performed on data from at least one of the tables via the first and second views.

16. The method as in claim 14, wherein the dynamically calculated value is based on one or more claims associated with a session with the database management system.

17. The method as in claim 16, wherein the database management system is configured to, in response to the session requesting access to at least one of the first view or the second view, dynamically calculate the value for the access control predicate.

18. The method as in claim 14, wherein the dynamically calculated value defines, at a row level, operations may be performed on data from at least one of the tables via the first and second views; and
wherein the dynamically calculated value is based on one or more claims associated with a session with the database management system.

19. The method as in claim 18, wherein the database management system is configured to, in response to the session requesting access to at least one of the first view or the second view, dynamically calculate the value for the access control predicate.

20. The method as in claim 14, wherein the declarative language code is written in the M language.
